(19) United States
(12) Patent Application Publication
(10) Pub. No.: US 2020/0180224 A1
(43) Pub. Date: Jun. 11, 2020

(54) 3D PRINTING METHOD AND APPARATUS

(71) Applicant: Aurora Labs Limited, Bibra Lake, Western Australia (AU)

(72) Inventor: David Budge, Bibra Lake, Western Australia (AU)

(73) Assignee: Aurora Labs Limited, Bibra Lake, Western Australia (AU)

(21) Appl. No.: 16/620,799

(22) PCT Filed: Jun. 6, 2018
(86) PCT No.: PCT/AU2018/000092

§ 371 Date: Dec. 9, 2019

(30) Foreign Application Priority Data
Jun. 6, 2017 (AU) 2017902156

(51) Int. Cl. B29C 64/245; B33Y 10/00; B33Y 30/00; B29C 64/153

(52) U.S. Cl. CPC B29C 64/245; B29C 64/153; B33Y 30/00; B33Y 10/00

(57) ABSTRACT

A printing apparatus is for printing a three-dimensional object. The apparatus includes a frame configured to rotate about an axis; an operative surface mounted to the frame; a powder dispenser mounted to the frame, the powder dispenser being configured to deposit at least one powder layer onto the operative surface; and an energy source mounted to the frame for emitting at least one energy beam onto the powder layer. Rotational movement of the frame causes the operative surface to exert a centripetal force on the powder layer for securing the powder layer on the operative surface.

### FIELD OF INVENTION

The present invention relates to additive manufacturing processes and, in particular, 3D printing.

### BACKGROUND

Three-dimensional (3D) printed parts result in a physical object being fabricated from 3D digital data by laying down consecutive thin layers of material.

Typically these 3D printed parts can be made by a variety of means, such as selective laser melting or sintering, which operate by having a powder bed onto which an energy beam is projected to melt the top layer of the powder bed so that it welds onto a substrate or a substratum. This melting process is repeated to add additional layers to the substratum to incrementally build up the part until completely fabricated.

The rise and proliferation of 3D printing has had a marked disruptive effect on the manufacturing industry globally and is progressively leading to the decentralisation of manufacturing. 3D printers now allow complex objects to be manufactured in remote locations where conventional manufacturing resources and infrastructure are not accessible.

This includes in outer space. For example, it is anticipated that 3D printing will allow for spare parts to be manufactured on demand by astronauts while orbiting the Earth in space craft or space stations.

Known 3D printing methods, however, do not operate effectively in low and zero gravity environments. This is primarily because it is not possible to keep the powders used in the manufacturing process static while being worked on by the energy beam.

It is an object of the present invention to provide a method and apparatus for printing 3D objects in low or zero gravity environments.

### SUMMARY OF THE INVENTION

In accordance with one aspect of the present invention, there is provided a printing apparatus for printing a three-dimensional object, the apparatus comprising:

a frame configured to rotate about an axis;

an operative surface mounted to the frame;

a powder dispenser mounted to the frame, the powder dispenser being configured to

deposit at least one powder layer onto the operative surface; and

an energy source mounted to the frame for emitting at least one energy beam onto the powder layer,
whereby rotational movement of the frame causes the operative surface to exert a centripetal force on the powder layer for securing the powder layer on the operative surface.

The frame may comprise a cylindrical centrifuge rotatable about an axis, wherein the operative surface is mounted to an inside surface of the centrifuge.

The powder dispenser may comprise first and second pivotally connected control arms, wherein the first control arm is rotatably connected to the centrifuge and a powder-dispensing nozzle is attached to the second control arm.

In accordance with one further aspect of the present invention, there is provided a method for printing a 3D object, the method comprising:
(i) rotating a frame about an axis:
(ii) while the frame is rotating, using a powder dispenser to deposit at least one powder layer onto an operative surface mounted on the frame;
(iii) while the frame is rotating, emitting an energy beam onto the powder layer to melt the powder layer, at least in part, thereby forming part of the 3D object; and
(iv) repeating steps (ii) and (iii) until the 3D object is complete.

During the first instance of step (ii), the operative surface may be the bed of the apparatus, although when repeating step (ii), the operative surface may be the preceding melted powder layer, so that the 3D object may be formed using a plurality of powder layers.

### BRIEF DESCRIPTION OF DRAWINGS

The present invention will now be described, by way of example, with reference to the accompanying drawings, in which:

FIG. 1 is a side view of a 3D printing apparatus according to an embodiment of the invention; and

FIG. 2 is a further side view of the 3D printing apparatus of FIG. 1.

### DETAILED DESCRIPTION OF THE DRAWINGS

Referring to the Figures, there is shown a printing apparatus 10 for printing a three-dimensional object. The apparatus 10 comprises a frame 12 configured to rotate about an axis 14, an operative surface 16 mounted to the frame 12, a powder dispenser 18 mounted to the frame 12, the powder dispenser 18 being configured to deposit at least one powder layer 20 onto the operative surface 16 and an energy source 22 mounted to the frame 12 for emitting at least one energy beam 24 onto the powder layer 20. Rotational movement of the frame 12 causes the operative surface 16 to exert a centripetal force on the powder layer 20 for securing the powder layer 20 on the operative surface 16.

More particularly, the frame 12 comprise a cylindrical centrifuge 26 rotatable about an axis 14. The operative surface 16 is mounted to an inside surface 28 of the centrifuge 26 and is curved such that it is aligned with the curved profile of the inside surface 28.

The powder dispenser 18 comprises first and second pivotally connected control arms 30,32. The first control arm 30 is rotatably connected to the centrifuge 26, preferably at the axis 14. A powder-dispensing nozzle 34 attached to an end of the second control arm 32.

The nozzle 34 is connected to a supply of powder, preferably via a supply tube (not shown), so that powder can be sprayed from the nozzle 34 onto the operative surface 16.

A revolute shaft 36 extends through the axis 14 substantially centrally within the centrifuge 26. A plurality of spokes 38 having an equal length extend radially from the shaft 36 to the perimeter of the centrifuge 26 for connecting the perimeter to the shaft 36. This provides that a uniform centrifugal force is exerted generally on the perimeter of the centrifuge 26 while the centrifuge 26 rotates.

The energy source 22 is mounted to the centrifuge 26 at the axis 14, preferably using a gimbal 40. The gimbal 40 allows the energy source 22 to be rotated freely about three dimensions so that the energy beam 24 can be directed onto any position on the operative surface 16.

The energy beam 24 can be any one of a laser beam, a collimated light beam, a micro-plasma welding arc, an electron beam and a particle accelerator. Preferably, the energy beam 24 has focusing means (not shown) being adapted to suitably focus the energy beam 24 so that an energy density being at least 10 Watts/mm³ is produced.

Where the energy beam 24 is a laser beam, the laser beam can be focused onto the operative surface 16 to a spot size of less than 0.5 mm². Similarly, where the energy beam 24 is a collimated light beam, the light beam can be focused onto the operative surface 16 to a spot size of less than 1 mm².

Further, where the energy beam 24 is a micro-plasma welding arc, the micro-plasma welding arc can be focused onto the operative surface 16 to a spot size of less than 1 mm². Such a micro-plasma welding arc is normally able to produce a focused beam of plasma gas at a temperature of about 20,000° C. with a spot size of about 0.2 mm².

In use, the centrifuge 26 is rotated about the axis 14 at a substantially uniform rotational velocity. While the centrifuge 26 is rotating, powder is deposited onto the operative surface 16 in layers 20 via the powder dispenser 18. Centripetal force acting on the layers 20 by the operative surface 16 provide that the layers 20 form a curved shape that aligns with the curved profile of the operative surface 16.

Each powder layer 20 is worked on by the energy beam 24 to melt or sinter the powder selectively, at least in part, to form part of the 3D object. This process is repeated for further layers of powder until the 3D object is fabricated in full.

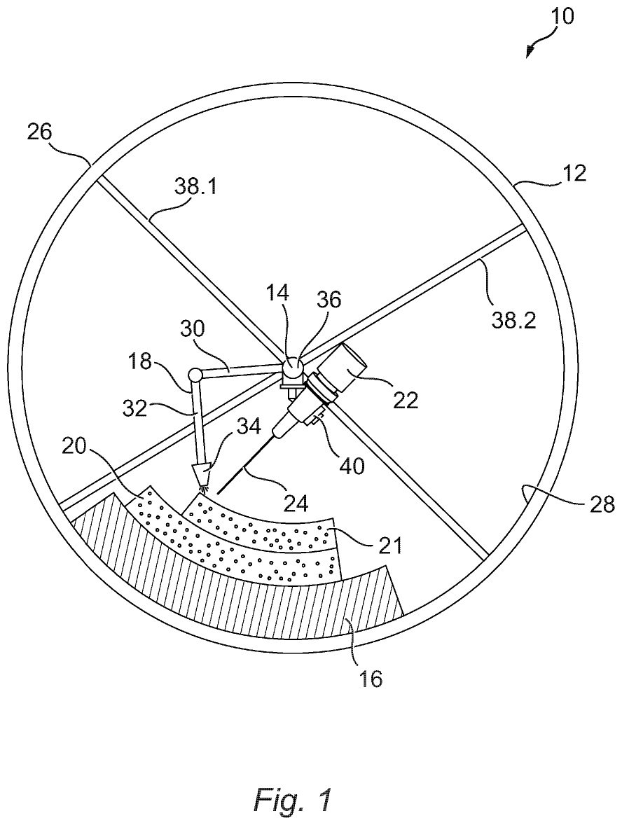

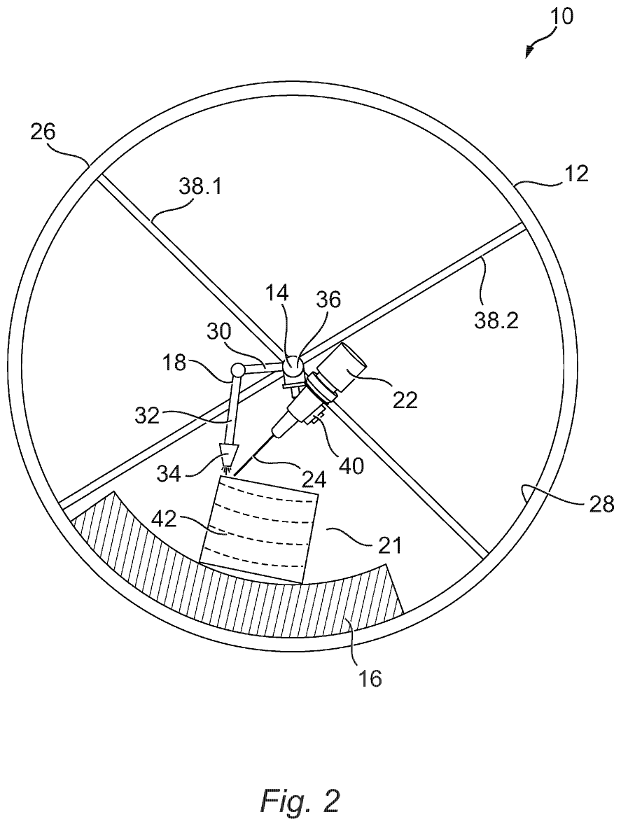

In FIG. 1, the apparatus 10 is shown in a state whereby two layers of powder 20,21 have been deposited onto the operative surface 16 and the energy source 22 is working on the topmost layer 21. In FIG. 2, the apparatus 10 is shown in a state whereby a 3D object (a cube) 42 has been almost completely fabricated by the apparatus 10.

The rotational movement of the centrifuge 26 advantageously provides that the layers of powder 20 deposited onto the operative surface 16 by the powder dispenser 18 remain static on the operative surface 16 when being worked on by the energy beam 24.

The rotational movement also provides that the powder is deposited into curved layers 20 that align with the curved profile of the operative surface 16. As illustrated in FIG. 2, the energy source 22 is configured to operate on the layers 20 such that objects having non-curved features (e.g., the 3D cube 42 that is depicted) may be fabricated using the apparatus 10 notwithstanding the curved profile of the deposited powder layers 20.

The operative surface 16 may extend around the entire 360 degrees of the inside surface 28 of the centrifuge 26.

The powder may therefore be deposited around an entire 360 degrees of the operative surface 16, thus forming a continuous bed of powder layers 20.

Modifications and variations as would be apparent to a skilled addressee are deemed to be within the scope of the present invention.

In the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

1. A printing apparatus for printing a three-dimensional object, the apparatus comprising:
a frame configured to rotate about an axis,
an operative surface mounted to the frame,
a powder dispenser mounted to the frame, the powder dispenser being configured to deposit at least one powder layer onto the operative surface, and
an energy source mounted to the frame for emitting at least one energy beam onto the powder layer,
wherein rotational movement of the frame causes the operative surface to exert a centripetal force on the powder layer for securing the powder layer on the operative surface.

2. The printing apparatus according to claim 1, wherein the frame comprises a cylindrical centrifuge rotatable about an axis, and the operative surface is mounted to an inside surface of the centrifuge.

3. The printing apparatus according to claim 1, wherein the powder dispenser comprises first and second, pivotally connected, control arms, wherein the first control arm is rotatably connected to the frame and a powder-dispensing nozzle is attached to the second control arm.

4. The printing apparatus according to claim 1, wherein the operative surface is curved and has an axis coaxial with the axis of rotation of the frame.

5. The printing apparatus according to claim 1, wherein the frame is connected to a shaft by a plurality of spokes.

6. The printing apparatus according to claim 1, wherein the energy source is mounted proximal the axis.

7. The printing apparatus according to claim 1, wherein the energy source is mounted using a gimbal.

8. The printing apparatus according to claim 1, wherein the operative surface forms a cylinder, extending around the entire 360 degrees.

9. The printing apparatus according to claim 1, wherein the energy source is configured to operate on each powder layer such that objects having non-curved features may be fabricated.

10. A method for printing a 3D object, the method comprising the following steps:
(i) rotating a frame comprising a cylindrical centrifuge about an axis:
(ii) while the frame is rotating, using a powder dispenser to deposit at least one powder layer onto an operative surface mounted to an inside surface of the centrifuge;
(iii) while the frame is rotating, emitting an energy beam onto the powder layer to melt the powder layer, at least in part, thereby forming part of the 3D object; and
(iv) repeating steps (ii) and (iii) until the 3D object is complete.

11. The method for printing a 3D object according to claim 10, wherein the operative surface of step (ii) is a print bed, upon which the 3D object is to be printed, in the first instance, and is the preceding powder layer in each subsequent repetition.

12. The printing apparatus according to claim 2, wherein the powder dispenser comprises first and second, pivotally connected, control arms, wherein the first control arm is rotatably connected to the frame and a powder-dispensing nozzle is attached to the second control arm.
